(19) United States
(12) Patent Application Publication
(10) Pub. No.: US 2002/0188583 A1
(43) Pub. Date: Dec. 12, 2002

(54) E-learning tool for dynamically rendering course content

(76) Inventors: Mark Rukavina, Scottsdale, AZ (US); Chris Dragon, Scottsdale, AZ (US); Mike Ray, Mesa, AZ (US); Jared Carman, Pheonix, AZ (US); Clayton Chamberlain, Cave Creek, AZ (US); Brian Buikema, Scottsdale, AZ (US); Peter Lenton, Phoenix, AZ (US); Marty Ulrich, Mesa, AZ (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/864,885

(22) Filed: May 25, 2001

(51) Int. Cl. G06F 17/00; G06F 17/60

(52) U.S. Cl. 706/45; 706/11; 434/322

(57) ABSTRACT

An e-learning tool that uses an object-oriented approach to permit easily-developed course content to be quickly produced in customized form for a plurality of users. An authoring tool uses a template-based system to create courses in the form of individualized learning objects, each learning object containing a learning objective, content, and an assessment item. Various graphics, audio and text are also embodied in object form, associated with the proper learning object(s), and stored within a database. A dynamic delivery tool accesses the objects for a particular course upon request by a student, and virtually instantaneously creates a course customized for that student based upon a profile of the student stored within a learning management system. In this way, course administrators and developers can update or otherwise manipulate the course simply by modifying the individual objects, and the student views only those objects that he or she desires or is capable of viewing. Thus, courses can be easily created to allow students to learn course content as quickly and conveniently as possible.

### BACKGROUND OF THE INVENTION

1. Field of the Invention

The present invention relates to computer-based tools for teaching courses to students. More particularly, the invention relates to computer-based learning tools that provide course content via a network.

2. Description of the Related Art

Computer-based training, also known as technology-based training or e-learning, has many advantages over traditional, classroom-based learning environments. For example, students may typically take advantage of the training at a particular time or in a particular geographic location that is convenient to them. Students may each proceed through the training at their individual paces, and obtain virtually instantaneous feedback as they do so. Moreover, computer-based training has the potential to be extremely cost-effective, particularly for large corporations that must train their employees as their employees are hired or otherwise as needed.

However, although there currently exist a myriad of conventional computer-based training techniques, these techniques have not effectively exploited the above, and other, advantages. Additionally, such conventional techniques suffer from a variety of drawbacks and disadvantages.

One example of a conventional computer-based training technique includes formulating course subject matter or content for inclusion on a CD-ROM or other storage media. The storage media can then be distributed directly to a number of students, who may then use a local computer to progress through the stored subject matter as they wish. This technique benefits from many of the advantages listed above, as well as from the use of typically inexpensive storage media. However, the storage media must be physically distributed to, e.g., mailed to, the individual students. Moreover, it is frequently difficult and expensive to develop the course content in the first place, since the course creators/authors, i.e., experts in the subject matter who are designing the content of the course(s), rarely have the technical skills necessary to design and implement a computer-based course, particularly when the course will contain multimedia content such as videos, graphics, audio, animation, etc. Additionally, it is prohibitively difficult and expensive to manipulate or update this type of course, since the course content must be manually configured and updated in a manner that is consistent throughout the course, and then re-distributed to the students. Finally, since they typically must be mass-produced in order to be cost-effective, such courses cannot be individually configured so as to match the specific needs of the users, so that, for example, students who are already somewhat familiar with a particular type of subject matter may have to sift through material with which they are already familiar.

A second type of computer-based training relies on a network such as the Internet to distribute course content, generally from a server to a plurality of individual network computers. More specifically, the course content is presented using a mark-up language such as HTML (hypertext mark-up language) via network computers using some type of browser to display the content. This technique has the advantage of potentially instantaneous distribution to students and does away with the need for local storage media to be distributed. However, this technique is still essentially a static presentation of pre-conceived slides of information and therefore continues to suffer from essentially the same drawbacks discussed above with respect to course development, manipulation, updating and individualization. These problems may be exacerbated by the need to implement an HTML version of the course content, and by the fact that the course content must be compatible with a variety of web browsers and operating systems. Moreover, distributing course content via the Internet may require users to implement certain plug-ins or downloads from the server and, depending on the student and the student's computer, may therefore hamper or completely deter the student from utilizing this type of computer-based training. Finally, depending on the connection capabilities of the student's computer, it may be difficult or impossible for the student to receive the course content due to, for example, bandwidth limitations that restrict the student from effectively receiving video, graphics, animated content, etc.

A third type of computer-based training also relies on a distributed network such as the Internet and uses XML (extensible mark-up language) in developing the course content. XML is a language that marks-up or “tags” the course content using user-defined designations for different types and sections of content, so that the tagged items may be recognized and acted upon during future processing. For example, section titles might be designated as such for the purpose of automatically generating a table of contents upon completion of the course design. Questions and answers within a course may be tagged separately so that an instructor version can be generated containing the answers, where the student version leaves the answers blank. This technique greatly increases the ease with which a course is updated since similar concepts can be similarly tagged throughout the document and, therefore, identified for alteration or deletion during the updating process. Additionally, such XML documents are typically platform, language and vendor independent, which makes their distribution over the Internet less complicated. Moreover, inasmuch as XML permits the separation of content from presentation, it allows authors to create documents using traditional word processing or spreadsheet applications that can then be used to directly generate Internet-ready documents.

However, the use of XML in computer-based training has unique difficulties and does not solve all of the problems mentioned above. For example, XML requires that the developer create all of the different types of tags (categories) to be used and requires that the contents of these categories be defined by various rules. Ideally, these different definitions, categories and rules should be parsed to ensure their consistency. Even if these tasks are successfully completed, the fact remains that the resulting course subject matter is simply a very large, static (albeit well-defined) document that must be constructed, maintained and delivered in its entirety. That is, the document is published such that its content and structure, and the relationships therebetween, are unchanged from delivery to delivery. Even if a viewer chooses to manipulate the data in the manner described above, e.g., a viewer chooses to see questions with or without the answers, the viewer is essentially simply choosing not to view a particular type of content within the document.

In summary, there are many types of computer-based training techniques that are currently available. However, none of these techniques fully exploit the potential of computerbased training in maximizing the learning, enjoyment and convenience experienced by each student, while simultaneously minimizing both the time required by the student(s) to experience the learning and the cost associated with developing, maintaining and delivering the course content.

Therefore, what is needed is a computer-based training system and method that permits easy and efficient development and maintenance of course content and delivers that course content to students in a manner that suits their individual needs with respect to accessibility, form and content.

### SUMMARY OF THE INVENTION

The present invention relates to an object-oriented approach to creating, maintaining and delivering course content in a manner that is efficient, convenient and effective for course developers, administrators and students. More specifically, the invention relates to a system and method for creating courses for students virtually instantaneously, where the courses are individually customized to the specific needs of those students.

The present invention provides for the above features, and more, by authoring virtually every component of a course, including graphical and textual presentation, learning objectives, subject matter content, assessment items and system capabilities, as objects to be individually stored. That is, these learning objects are authored and then individually stored in a database, and are not, prior to delivery to a student, “hard-wired” together in published document form. Instead, a learning management system determines a profile of a student. Objects are then dynamically selected for delivery to an individual student on the basis of being matched to certain requirements of that student, based on the profile.

Using the above-described features, the invention may deliver individually-customized courses to every student. For example, the invention may determine, through the use of assessment items, that a particular student already has proficiency in a certain subsection of a course. Since the course material is stored as individual objects, the invention can then simply construct a course for that student that does not include that course subsection. Similarly, the invention may determine that a student has a relatively slow Internet connection and thus may create a course for that student that does not include objects related to video or animation.

In one embodiment of the invention, authoring of the objects is template-based. In this manner, course developers with no specific programming knowledge may input course information through the use of template-based content editors. The course developers may preview the courses during development, via the use of a web browser. Since all course elements will ultimately be expressed as individual, discrete objects, it is easy to divide the labor of course development. For example, subject matter experts may compose text related to the particular subject matter, while graphics experts create associated video or animation clips. This methodology permits extremely fast and efficient course creation.

In the course authoring process, the various elements of the course are functionally decomposed into individual objects, topically organized and hierarchically crafted, so that the objects can then be semantically described and stored within a database.

Thereafter, when a student requests the course, a matching or rendering engine determines which of the stored objects should be delivered to the student. The rendering engine operates by matching objects within the database to the student's profile as stored within a Learning Management System (LMS). For example, the rendering engine may determine that an object(s) concerned with a particular learning objective should not be included in the course creation, based on the fact that the student has already correctly answered an assessment question related to that learning objective. Similarly, the rendering engine may determine that the student's profile specifies that no video should be delivered since the student may be using a slow modem connection to receive the course.

In this way, a student may instantaneously receive a course that has been individually created for him or her. The student may thus attain a desired level of proficiency in the course subject matter in a minimum amount of time; that is, the student receives a course that presents only the required amount of information in a minimum amount of time.

Moreover, the invention allows for extremely easy and fast course updates. This is because updates need only be performed with respect to a particular learning object(s) and then that object(s) can be stored in the database for immediate release as part of a course if required by a particular student. There is no need to take an entire course off-line to update, re-compile, re-publish, etc.; rather, the new object can be immediately utilized. Finally, since the objects are independent of one another with respect to actual course delivery, a defective or outdated object can be disregarded so that the system as a whole is very robust and reliable.

The features and advantages of the invention will become apparent from the following drawings and description.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a functional block diagram of an embodiment of an e-learning tool in accordance with the present invention.

of the invention.

FIG. 3 illustrates a first page of course content rendered by an embodiment of the invention.

FIG. 4 illustrates a second page of course content rendered by an embodiment of the present invention.

FIG. 5 illustrates a page showing a learning campus as rendered by an embodiment of the present invention.

FIG. 6 is a flow chart describing an e-learning system development process according to an embodiment of the invention.

FIG. 7 is a diagram of an exemplary technological implementation for an e-learning tool in accordance with the principles of the present invention.

### DETAILED DESCRIPTION

While the present invention is described below with respect to various exemplary embodiments, the present invention is not limited to only those embodiments that are disclosed. Other embodiments can be implemented by those skilled in the art without departing from the spirit and scope of the present invention.

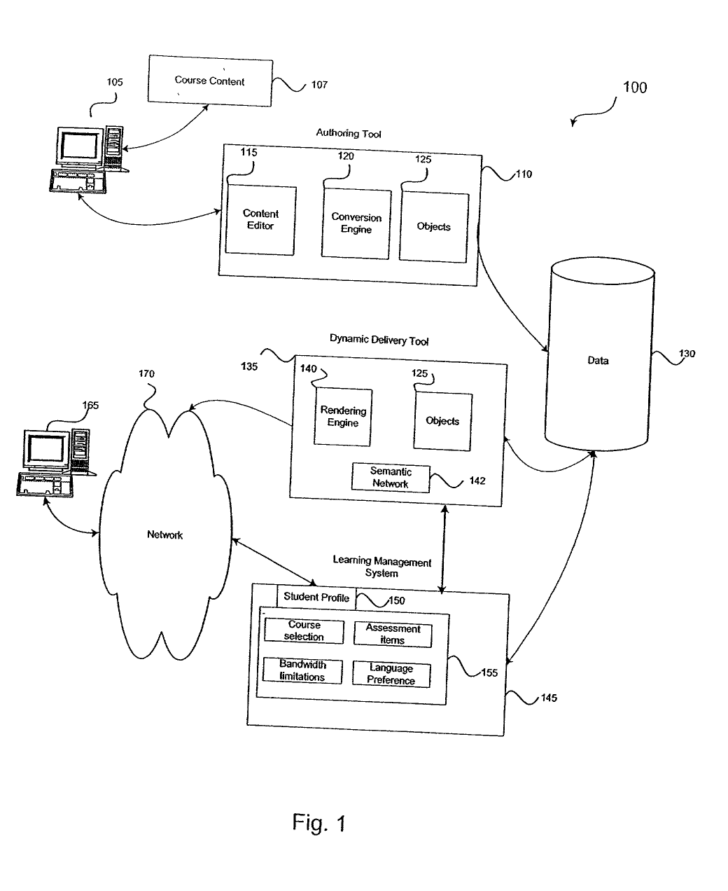

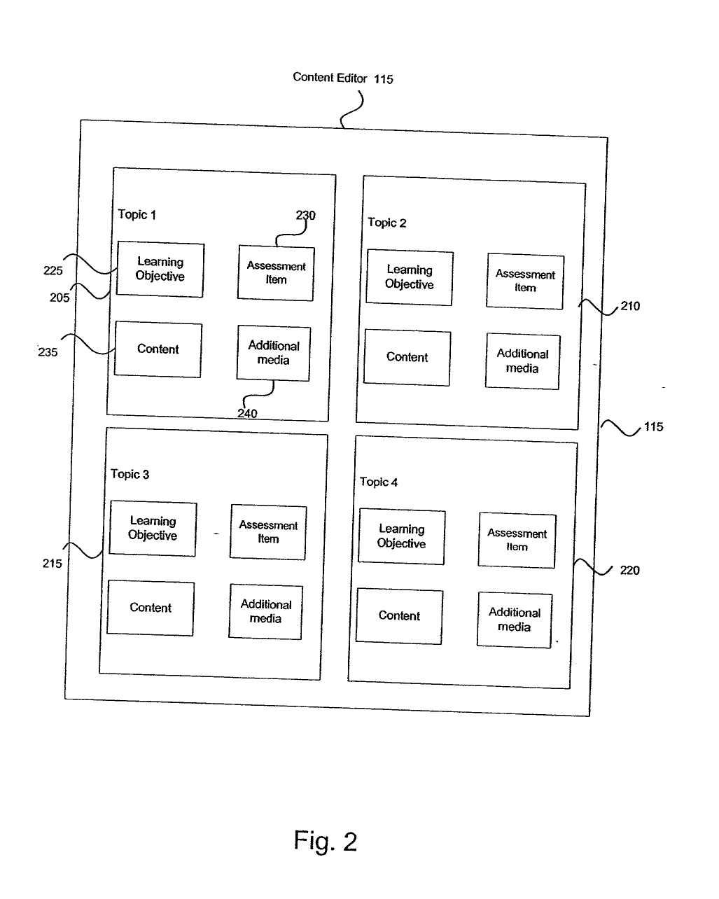

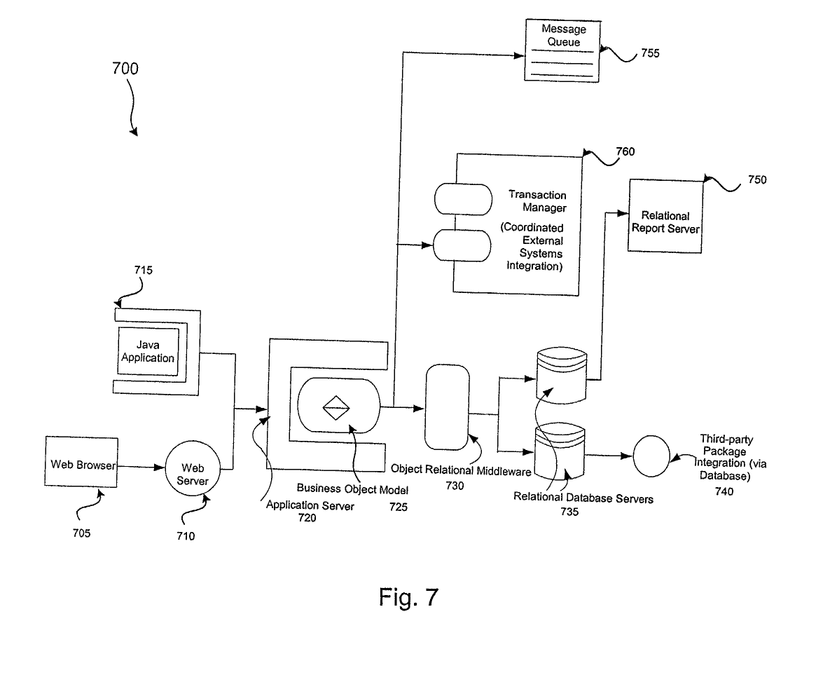

FIG. 1 illustrates a functional block diagram of an embodiment of an e-learning tool 100 in accordance with the principles of the present invention. A description of an exemplary technical implementation of this embodiment is discussed in connection with FIG. 7. As will be described further below, e-learning tool 100 includes an authoring tool 110, a dynamic delivery tool 135, and a Learning Management System (LMS) 145. Authoring tool 110 is fast, flexible and easy-to-use, allowing subject matter experts, instructional designers, graphic designers, and other course development team members to work simultaneously on individual learning objects 125, as will be further defined below. Dynamic delivery tool 135 is capable of “on-the-fly” rendering of learning objects 125, and is capable of custom assembly of the objects 125 such that each student receives only those objects that are required for, or desired by, the student. Finally, LMS 145 gives each student and administrator detailed information about the learner's preferences and progress through assigned courses, and provides a detailed profile of the student's delivery parameters so that course content can be custom-made for the student by the dynamic delivery tool 135.

In FIG. 1, a course developer at workstation 105 interacts with a template-based content editor 115 of authoring tool 110 to develop course content. It should be noted that a course developer could be one or more persons working within a third-party course-development company or an individual subject matter expert, such as a course administrator developing courses for a large corporation. Additionally, workstation 105 could be a conventional personal computer, where the authoring tool 110 might be accessed through a conventional browser such as Netscape™ or Internet Explorer™. Alternatively, workstation 105 might be embodied as an applications server that is directly accessed by the course developer.

Content editor 115 allows the developer to easily input externally-provided course content 107 into the system 100, even without having specialized programming knowledge. Course content might comprise text, audio clips, video clips, animation, Flash technology, etc. Although not explicitly shown, these various components of a course's content can be authored by a plurality of developers working simultaneously at a plurality of workstations; that is, a graphic designer might author various graphics, while a subject matter expert might author various sections of text. In this way, course content can be authored in parallel, so that courses can be developed as rapidly as possible.

An embodiment of content editor 115 is illustrated in FIG. 2. As shown in FIG. 2, content editor 115 provides a course developer with the ability to break the course subject matter down into a variety of topics 205, 210, 215, 220. Each topic may include, for example, a learning objective 225, assessment item 230, content 235, and any additional media 240. Learning objective 225 concisely states the information to be transferred in its entirety via course content 235. An assessment item 230 might be, for example, a test question or questions that are designed to determine whether the student has mastered the learning objective. Additional media 240 such as video, audio, etc. can also be input via content editor 115. As mentioned above, not every section of content editor 115 need be filled out in its entirety by a given course developer; rather, a number of course developers can work together simultaneously to input all relevant course information, via a plurality of the content editors 115. As also mentioned above, content editor 115 illustrates an embodiment of a template-based methodology that might be used in accordance with the present invention. A content editor may also include other features such as “drag-and-drop” menus, icon-driven selection means or toolbars to select/formulate course content, conventional word processing applications, spreadsheet or presentation slide features, etc. Moreover, course content can be broken down into any categories and/or subcategories as necessary, depending on the nature of the course content.

Once content has been generated using content editor 115 at workstation 105, conversion engine 120 accepts the template and functionally decomposes the course content into learning objects 125 having various behaviors, classifications and interfaces, and defines the relationships therebetween. Conversion engine 120 might be a Java application or an application of any object-oriented programming language, such as SmallTalk or C++.

Each learning object 125 may include the learning objectives, course content and assessment items. In defining the learning objects for a course, every aspect of the course associated with the ultimate presentation of that course is separately and semantically described as an object. For example, a given sub-topic might have several paragraphs of text, several video or audio clips, “buttons” for students to click on for navigation, etc. Each of these is described as an individual object, having its own purpose within the overall context of the course to be presented. Once learning objects 125 have been authored by authoring tool 110, they can be forwarded to database 130 for storage.

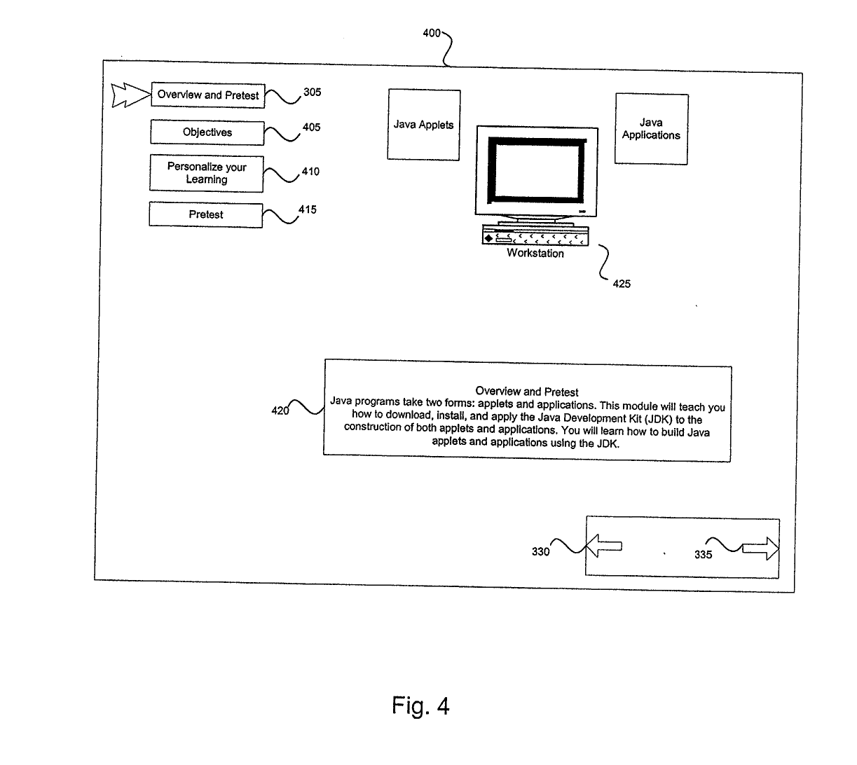

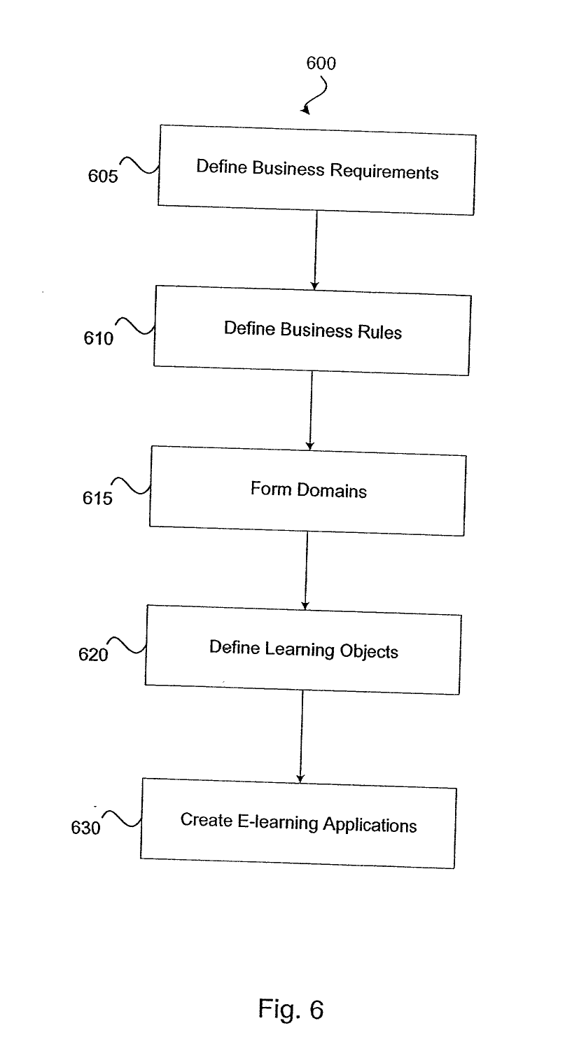

It should be noted that, for the purposes of this disclosure, an object is considered to be a software construct or programming entity that bundles together code, i.e., procedures, with the data upon which the code (procedures) will operate. The concept and advantages of object-oriented programming are, at least on a theoretical level, generally well-known. For example, objects may “inherit” characteristics from one another so that a developer does not need to create every new concept from scratch, and updates to existing objects are generally easy to implement. Also, objects can generally be shared between multiple applications as long as the individual objects can support the interfaces expected by the applications. The specific role(s) of such objects in designing and implementing the present invention will be discussed in greater detail in connection with FIGS. 6 and 7. However, with respect to FIGS. 1-4, it is sufficient to understand that learning objects in the context of the disclosed embodiment of the invention are individual, dynamic entities embodying discrete concepts associated with a particular course and its content and/or presentation. These learning objects can be dynamically assembled and delivered to each student in a manner that matches that student's needs, as will be discussed hereinafter with respect to database 130, dynamic delivery tool 135 and LMS 145.

Specifically, dynamic delivery tool 135 loads objects 125 upon a request for a course from a student operating at workstation 165 through network 170, which may be the Internet. Thereafter, rendering engine 140 decides which of the objects 125 will be delivered to the student at workstation 165, based upon information pertaining to that student contained within LMS 145. For example, rendering engine 140 might determine which objects 125 to assemble and deliver based on a semantic match, facilitated by semantic network 142 within dynamic delivery tool 135, between objects 125 and student information contained within LMS 145. Semantic network 142 can generally be thought of as a graph for demonstrating features and relationships of objects 125 to be used in matching to information within student profile 150.

Any objects 125 that embody media can be streamed to the student, meaning the student need not wait for cumbersome downloads to complete, and does not have to house media files on his or her own computer.

LMS 145 is capable of containing an extensive amount of information pertaining to a student or set of students. LMS 145 might contain information as to subject areas where the student has demonstrated proficiency or aptitude. For example, the LMS might track the student's scores obtained on previously-administered pretests. The LMS may contain information as to the student's preferences for a language to be used in administering a course, or preferences for whether video should be used. Even if the student prefers video, however, the LMS 145 may determine that video should not be utilized if the student is using a network link having certain bandwidth limitations. Such bandwidth limitations can be sensed by the system or can be specified by either the student or by an administrator overseeing a course administration to a plurality of students. Other examples of information available in LMS 145 are bookmarks of where a student has been within a course(s), amount of time spent by the student in different subject areas, attendance statistics at a course that was administered live, etc. These types of information stored within the LMS 145 allow dynamic delivery tool 135 to choose exactly which objects 125 associated with a particular course should be rendered to the student.

All of the above information and more can be stored as profile elements 155 within a student's individualized profile 150. These individual profile elements 155, which can also be constructed as individualized objects for persistent storage within database 130, serve as the basis for comparison or matching with objects 125 by rendering engine 140 within dynamic delivery tool 135. Thus, courses can be delivered virtually in real-time over the Internet or as self-paced robust interactive courses. For every course offered, students have access to interactive realistic Internet-based labs for practice and review; they can be provided with constant access to online mentors who will guide them through questions and problems; and they can chat online with groups of their peers about the content and discuss real-life applications of their knowledge, further filling out the e-learning experience.

Moreover, based upon the matching as described above between dynamic delivery tool 135 and LMS 145, dynamic delivery tool 135 can dynamically render every course page from objects 125 to custom make each course for the particular student on the fly from the database 130 of objects 125 to meet the specific needs of the user. Thus, each page of a course can be assembled and delivered in real-time over the Internet.

A variety of protocols and APIs (application program interfaces) can be utilized as conduits for information traveling between LMS 145 and dynamic delivery tool 135 to support adaptive learning. In this way, a plurality of course structures and requirements, as well as learning management systems, can be supported by the present invention.

Having described an embodiment of the invention with respect to FIGS. 1 and 2, FIGS. 3-5 demonstrate several exemplary pages of course content that might be generated by an e-learning system implementing this embodiment of the invention.

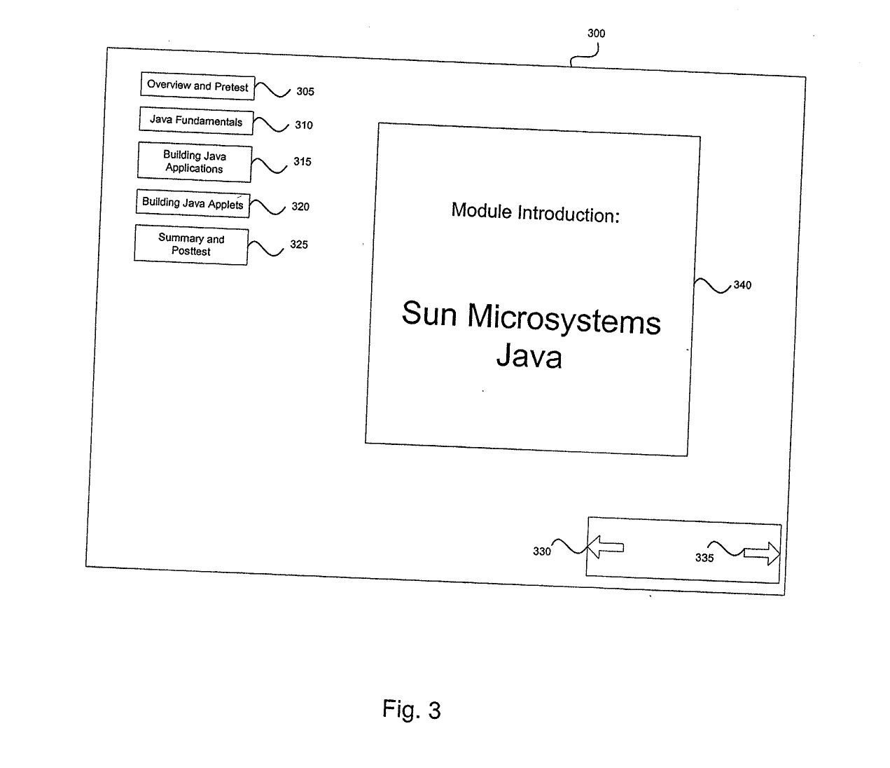

In FIG. 3, a page 300 is shown illustrating an introduction for a module concerning a course in Sun Microsystem's Java programming language. The page 300 includes buttons 305-325, each of which is an object as described above, and which provide an overview of sub-topics of the course content that will be covered and which also serve as links to those sub-topics. Arrow buttons 330 and 335, also objects, allow a student to negotiate backwards and forwards through a course, as desired, and object video graphic 340 presents introduction information as to the topic.

A user may click on button 335 to advance to page 400, which is the first of a series of pages under the “overview and pretest” sub-topic represented by button 305. Thus, on this page, buttons 405-415 represent further divisions of sub-topic 305. Text 420 provides information relating to sub-topic 305 and video graphics 425 illustrate concepts related to the information provided within text 420.

It should be noted that, at a time when the student clicks on button 335 to advance from page 300 to page 400, page 400 does not yet physically exist prior to the input from the student to the e-learning system 100 for requesting course content, e.g., the click to advance from page 300 to page 400. The content that will ultimately comprise page 400, prior to the click by the student, merely exists as a collection of objects representing the various components 305 and 405-425, as explained above. These objects are dynamically assembled and rendered “on-the-fly” by the dynamic delivery tool 135 as a course page when the student clicks on button 335. This rendering process is designed to occur in approximately 3 seconds or less.

As discussed above, the objects representing components 305 and 405-425 are selected for showing to a student based on profile elements 155 within the student's profile 150. In this case, for example, the student's profile dictated that paragraph 420 be in English, and the inclusion of video 425 was acceptable and desirable by the student. However, a second student studying the same subject matter might simultaneously click on button 335 and receive text 420 in Spanish or some other language, and might not receive video 425 at all. A third student might receive text 420 in Spanish, but might receive video 425. All three students can receive these three separate renderings of page 400 virtually instantaneously and simultaneously; in this way, the students each receive an e-learning experience individually suited to his or her needs and/or preferences. Thus, e-learning system 100 instantly generates custom pages of content from a database of learning objects to meet the needs of any particular student.

Buttons 410 and 415 relate to an even further personalization of the e-learning experience for the student. Specifically, button 410 permits personalized learning, for example through button 415 that represents a pretest to be administered to the student concerning all, or a representative portion, of the subject matter. The results of the pretest are then stored within the student's profile 150. In this way, the student can avoid experiencing lessons that concern subject matter with which the student is already familiar.

For example, a pretest concerning the subject matter overviewed in page 400 might test a student's knowledge of how to download, install and apply the Java Development Kit, and how to build Java applets and applications. If a particular student demonstrates knowledge of the use of the Java Development kit in constructing Java applets, but seeks to learn more about more advanced Java applications, then that information could be stored in that student's profile. Thereafter, a course would be constructed for that student that deals only with building those advanced Java applications with which the student is not yet familiar. In this way, the student would learn the desired information in a minimum amount of time. Of course, regardless of whether a student answers some or all of the pretest questions correctly, he or she would still be allowed the option of experiencing the complete course, if desired.

In accordance with another feature of the present invention, LMS 145 can also be used as a tool to present a “campus” of courses to a student. That is, since every student may have taken some different combination of courses, it may be useful to categorize available courses and present them to the student in a manner consistent with that student's experience. Such a campus may also be presented to administrators and course developers who wish to gain access for administering existing courses and/or developing/updating new courses.

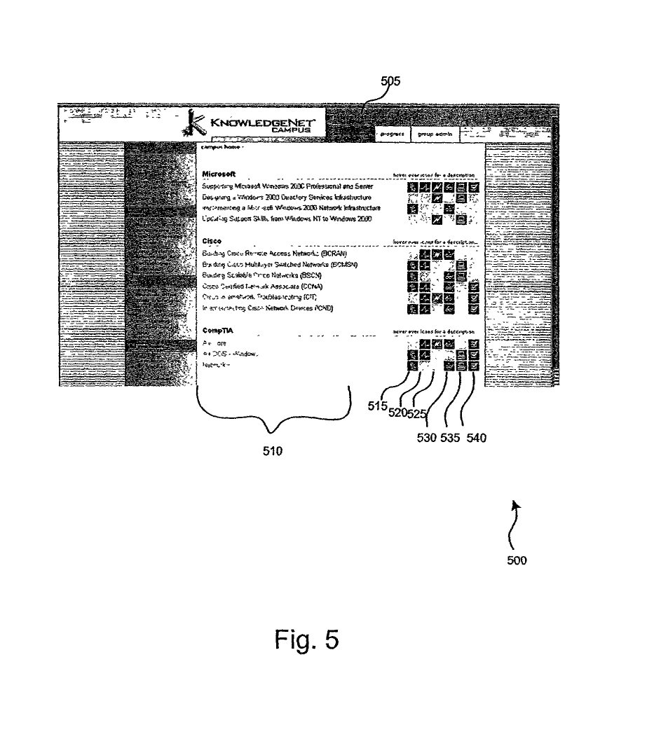

FIG. 5 illustrates a page 500 showing a learning campus as rendered by an embodiment of the present invention. In FIG. 5, item 505 (“Welcome Fred Johnson”) illustrates the personalized nature of an LMS campus. A user may be a student who has taken or will be taking a particular course, or may be an administrator responsible for overseeing a plurality of students. Such a campus may represent a plurality of courses and sub-courses 510 to the student. Each course may be experienced by the student in a plurality of manners, as referred to above with respect to dynamic delivery tool 135. For example, items 515-540 illustrate a plurality of e-learning options for each course, including interactive e-learning 515, live e-learning 520, Express e-learning 525, Mentored e-learning 530, labs 535 and assessment 540.

Interactive learning 515 generally refers to a self-paced model of learning for anywhere, anytime learning. Live learning 520 represents live (synchronous) online learning designed to mimic instructor-led brick-and-mortar classroom courses. Express e-learning 525 refers to the recording of live e-learning 520 so that students who are unable to attend or who want a review can re-live the live experience on their own time. These recorded events allow students to go to any chapter or topic in the course without scrolling through the entire program. Labs 535 refer to hands-on learning experiences that can be administered in conjunction with another of the e-learning experiences, or on an individual basis. The labs 535 allow students to implement lessons learned during other aspects of the e-learning experience. Finally, assessment 540 refers generally to testing of the student to determine the student's level of knowledge in a particular area. The testing can be either before or after any other e-learning experience 515-535. Each of these e-learning options for each course can incorporate the principles of the present invention as discussed above.

The above discussion has provided a functional description, with examples, of an embodiment of the invention. The following is an exemplary embodiment of a technological implementation of the present invention, together with additional features of the invention.

FIG. 6 is a flow chart 600 describing a process for developing an implementation of an e-learning system 100 of the present invention that would include the applications discussed previously, i.e., authoring, delivery and LMS. In developing an implementation of the present invention, it can be advantageous to start by identifying a plurality of business requirements 605 that define necessary or desired features of the ultimate implementation. These business requirements should be fairly non-technical and define high-level functional requirements of the system that are easily understood and that each semantically define a specific aspect of the desired e-learning system. For example, a business requirement of a particular implementation might be that pages should be rendered in 3 seconds or less. A second business requirement might be that authoring content editors should be available for course developers with no programming experience to use.

Business requirements 605 can then be analyzed to define various associated business rules 610, so as to reorganize high-level requirements into a collection of rules, each having a specific purpose and capable of functioning together. For example, a business rule for the embodiment discussed above might be used to determine whether a particular administrator or student has access to a course, or the ability to modify a particular course. A second business rule might dictate that a student who answers pretest questions correctly and chooses a personalized learning path through the associated course will not be shown the remaining sections of the course.

Once business rules 610 are formulated, domains can be formed in step 615 to describe groups of business activities that each include sets of learning objects. These objects will be discussed in more detail below. For example, one domain might be responsible for capturing what a learning object is, including the objective, content and assessment items. A second domain might be responsible for multiple language support, e.g., expressing one piece of course content text in both English and Spanish.

Once domains are established, they can be used in step 620 to create and categorize the actual, reusable learning objects discussed above. It is explicitly noted here that these learning objects are independent of any of the specific applications discussed above, such as the authoring tool, dynamic delivery tool or LMS. This application independence allows sharing of the objects between the applications, and flows naturally from the correspondence between the business requirements and rules to the actual software objects being designed.

At this point in the implementation process, the various aspects of the invention remain very straight-forward and intuitive to any administrative and/or corporate developers of the invention, even though they have now begun to be expressed in code. In order to maintain this level of understanding as the code is further developed and implemented, it can be helpful to model the ultimate implementation of the application (s) code. In this regard, a modeling language such as the Unified Modeling Language (UML) can be helpful.

Once UML diagrams are formulated, specific software applications for a specific implementation of an e-learning system in accordance with the principles of the present invention can be developed therefrom in step 630. For example, authoring tool 110, dynamic delivery tool 135 and LMS 145 are all applications that will be developed for the particular implementation of an e-learning system. The applications, as with the learning objects themselves, can be developed in any number of object-oriented languages, such as Java, SmallTalk, C++, etc.

As alluded to above, the various objects are defined at a high-enough level so that they can be used easily and independently by each of the application components. For example, the learning objects and profile objects should be capable of semantic matching so that the application itself does not have to apply complex logic to obtain its data. In fact, the objects should be close in semantics to both the needs of the students/administrators/course developers, as well as the application software itself.

It is noted here that the term “semantics” is used to define what a set of words or concepts mean to express, or what functions are requested, as opposed to the mere syntax of a set of terms. Semantic matching is performed by the rendering engine 140 as discussed above as one methodology for dynamically rendering appropriate course content to a given user based on that student's profile within LMS 145.

In summary of the development process, the end result is that applications are written in objects, e.g., Java, having certain classifications and behaviors. The learning objects are used by the rendering engine 140 in dynamically delivering course content to a student. The abstracted description of classified teaching/learning behavior as objects, as well as the creation of methods within those classes/objects that describe that behavior, provides for dynamic, individualized, robust and easily-updateable course content assembly and delivery in accordance with the principles of the present invention. The invention philosophically approaches learning with classified behavior and expresses that classification in Java objects or Java classes, which is what is being seen when a computer screen is painted with a course page that is dynamically rendered.

Turning to FIG. 7, a diagram of an exemplary technological implementation 700 of the present invention is shown. In FIG. 7, a student, administrator or course developer may access the system via browser 705, such as Netscape Navigator™ or Microsoft's Internet Explorer™. These browsers typically access a web server 710, such as Apache or IIS, which (as a general matter) is capable of delivering either static or dynamic pages to the browser(s). The web server 710 then accesses application server 720. Application server 720, such as that provided by Web Logic, serves to deliver a scalable platform for serving dynamic content to the web server, wireless applications, etc. It provides a fault-tolerant platform for the software applications discussed above. Alternatively, such a user may access the software applications directly through a Java application 715 interacting with application server 720.

Business object model 725 is where objects and object behaviors are maintained, and relationships and classifications of behaviors to functionally decompose the learning experience are manipulated. The business object model 725 describes the business requirements in an architectural drawing separated into the functional domains discussed above, and thereby describes the details of the object structure, interfaces between objects, and other object-oriented features and functions.

In implementation 700, the objects that are manipulated within business object model 725 are stored within relational database servers 735. Such databases by themselves are well-known, and are provided by, for example, Oracle or PostGres. Object relational middleware 730, such as that provided by TopLink, can be used to map the objects from the business object model 725 into the relational databases 735. Alternatively, an object database could be used to store the objects. Third-party package integration 740 refers to software that provides specific functionality publicizing certain well-defined Application Program Interfaces, and thereby provides the ability to interface with Saba, e-commerce, reporting packages and other third-party applications that can interface with the e-learning training system of the present invention.

Relational report server 750 is a report package that enables identification of specific reports within relational databases 735, and thereby satisfies reporting requirements for the present invention. Such servers can be obtained from companies such as Crystal Reports or Brio. Thus, implementation 700 is capable of bridging the gap between the object model and relational reporting.

Message Queue 755 refers to a queue structure that enqueues incoming events, stores them in the queue, and dequeues for asynchronous retrieval of events. Queue 755 is embodied, for example, by Microsoft, and may be used in the present invention to queue events between the e-learning system's applications, such as between the dynamic delivery tool 135 and LMS 145. For example, as dynamic delivery tool 135 is rendering the course, it may be accumulating attendance statistics and capturing test scores. The dynamic delivery tool 135 would then forward the attendance statistics and test results, via the message queue, to LMS 145.

Finally, Transaction Manager 760 provides integrity by ensuring that transactions do not get lost or damaged. That is, implementation 700 can be thought of as being comprised of three transaction sets—Student, System Management and Content Registration—where a transaction set is generally known to be an isolated grouping of information that is automatically exchanged, generally in response to a request. The Student transaction set has four subsets: tracking and communicating session, performance, attendance and learner profile information. The System Management transaction set controls communication between LMS 145 and the dynamic delivery tool 135. The Content Registration transaction set identifies content that is available and ready for configuration. Transaction Manager 760 manages these transactions and ensures that synchronization occurs between disparate systems through transaction coordination. It is used to balance the load between users, applications servers and database servers, and is also used to create a high availability system by switching a failed transaction to another machine. Such Transaction Managers 760 can utilize, for example, Java messaging services (JMS) from a JMS provider.

In conclusion, the present invention provides a system and method for virtually instantaneously creating courses for students, where the courses are individually customized to meet the specific needs of those students. The present invention permits fast, reliable, efficient and customized courses for students. These courses can be developed by any subject matter expert, even if he or she does not have programming experience. Moreover, the courses can be easily and quickly updated to reflect any changes in the subject matter content.

The present invention provides for the above features, and more, by authoring virtually every component of a course, including graphical and textual presentation, learning objectives, subject matter content, assessment items and system capabilities, as objects to be individually stored. That is, these learning objects are authored and then individually stored in a database, and are not, prior to delivery to a student, “hard-wired” together in published document form. Rather, the objects are dynamically selected for delivery to an individual student on the basis of being matched to certain requirements of that student, based on a profile of that student. The profile is determined by, and stored in, the learning management system.

When a student requests the course, a matching or rendering engine determines which of the stored objects should be delivered to the student. As discussed above, the rendering engine operates by matching objects within the database to the student's profile as stored within the LMS.

In this way, a student may instantaneously receive a course that has been individually created for him or her. The student may thus attain a desired level of proficiency in the course subject matter in a minimum amount of time; that is, the student receives a course that presents only the required amount of information in a minimum amount of time.

While this invention has been described in various explanatory embodiments, other embodiments and variations can be effected by a person of ordinary skill in the art without departing from the scope of the invention.

What is claimed is:

1. A system for providing an e-learning course, comprising:
a database for storing a plurality of reusable learning objects and a profile of at least one student that defines a plurality of course requirements of the student; and
a dynamic rendering engine responsive to the student profile and operable to assemble a subset of the learning objects on-the-fly for delivery to the student.

2. The system of claim 1, wherein each of the learning objects represents a discrete element of the subject matter or presentation of the e-learning course.

3. The system of claim 1, wherein the profile includes a technological capability of a computer system being utilized by the student.

4. The system of claim 3, wherein the technological capability is bandwidth available to the student for receiving the e-learning course.

5. The system of claim 1, wherein the profile includes a course preference of the student.

6. The system of claim 5, wherein the course preference includes a language preference of the student in receiving the e-learning course.

7. The system of claim 1, wherein the profile includes information as to learning objectives with which the student is familiar, whereby the dynamic rendering engine assembles the e-learning course without learning objects that contain the familiar learning objectives.

8. The system of claim 7, wherein at least one of the learning objects includes an assessment item for determining the learning objects containing familiar learning objectives.

9. The system of claim 1, wherein each learning object is classified in a first classification based on at least one of a plurality of learning objectives each representing at least a sub-topic of the e-learning course.

10. The system of claim 9, wherein each learning object is classified in a second classification based on a defined purpose of the learning object in the e-learning course.

11. The system of claim 1, wherein the dynamic rendering engine delivers the e-learning course to the student via a computer network.

12. The system of claim 1, further comprising:
a template-based authoring engine for generating the learning objects.

13. The system of claim 1, wherein the student profile comprises a plurality of profile objects, wherein each profile object embodies one of the plurality of course requirements of the student.

14. The system of claim 13, wherein each learning object includes a semantic description and each profile object includes a semantic description.

15. The system of claim 14, wherein the dynamic rendering engine assembles the subset of learning objects by matching elements of a learning object semantic description with elements of a profile object semantic description.

16. The system of claim 1, further comprising a learning management system to manage student information and guide student learning for the student and for a plurality of students.

17. An e-learning tool comprising:
an authoring tool operable to create a plurality of learning objects;
a dynamic delivery tool operable to dynamically assemble and deliver a course page of instruction embodying at least one learning object to a student in response to a request by the student; and
a learning management system containing a student profile of the student;
wherein the dynamic delivery tool determines the at least one learning object based upon the student profile.

18. The e-learning tool of claim 17, wherein the authoring tool includes a template-based content editor for creating the plurality of learning objects.

19. The e-learning tool of claim 17, wherein each learning object is categorized in one of a plurality of hierarchical classes, and further wherein each of the learning objects within a first class of the plurality of hierarchical classes contain a learning objective, an assessment item and a subsection of course content.

20. The e-learning tool of claim 19, wherein the dynamic delivery tool determines the at least one learning object based upon whether an administration of the assessment item determines whether the student is familiar with a learning objective corresponding to the learning object.

21. The e-learning tool of claim 20, wherein the student profile contains a language preference of the student for delivery of the course page of instruction.

22. The e-learning tool of claim 21, wherein the student profile includes a technical capability of a computer system used by the student to receive the course page of instruction.

23. The e-learning tool of claim 22, wherein the technical capability is an amount of available bandwidth.

24. The e-learning tool of claim 17, wherein the learning management system presents course information to the student in a form of a campus that summarizes which of a plurality of courses are available to the student and which of the available courses the student has already taken.

25. The e-learning tool of claim 17, further comprising a database for storing the plurality of learning objects and the student profile.

26. The e-learning tool of claim 25, wherein the student profile comprises a plurality of profile objects, wherein each profile object represents a course delivery directive, and further wherein the course delivery directive includes a course preference of the student, a course requirement of the student, or a course requirement of a course administrator.

27. The e-learning tool of claim 26, wherein each learning object includes a semantic description and each profile object includes a semantic definition.

28. The e-learning tool of claim 27, wherein the dynamic delivery tool determines the at least one learning object by matching elements of a learning object semantic description against elements of a profile object semantic description.

29. The c-learning tool of claim 28, wherein the learning objects and profile objects are manipulated within a business object model engine.

30. The e-learning tool of claim 29, wherein the database is a relational database.

31. The c-learning tool of claim 30, further comprising an object-to-relational mapping tool operable to map learning objects and profile objects into the relational database for storage.

32. A system for formulating and distributing an e-learning course, comprising:
a first software application that receives e-learning content and categorizes the content into classes of discrete elements, each discrete element representing a separate characteristic of the e-learning course and its presentation, the classes of discrete elements having pre-defined behaviors and relationships therebetween;
a second software application that receives information regarding a student's requirements for the course; and
a third software application that correlates the received information with the classes of discrete elements so as to automatically and dynamically assemble and render the discrete elements as an e-learning course customized to the individual requirements of the student.

33. The system of claim 32, wherein the student information identifies a language preference of the student, a technological capability of a computer system used by the student to access the e-learning content, and information as to e-learning content with which the student is familiar.

34. The system of claim 32, wherein the discrete elements are created and classified according to a plurality of business requirements for delivery of the e-learning content.

35. The system of claim 34, wherein the discrete elements are used in creating a Uniform Modeling Language (UML) diagram for modeling the software applications.

36. The system of claim 35, wherein the software applications are based on the UML diagram and written in Java.

37. A method for dynamically delivering a page of e-learning course content to a user, comprising:
storing a plurality of discrete learning objects within a database; and
assembling and delivering the page including at least one of the learning objects in response to an input from the user in approximately real-time to the user, based upon individual delivery parameters of the user.

38. The method of claim 37, wherein each of the learning objects pertains to presentation, content or delivery of the e-learning course.

39. The method of claim 37, further comprising:
creating the learning objects by utilizing a template-based authoring tool.

40. The method of claim 37, wherein said assembling and delivering the at least one of the learning objects in response to an input from the user in approximately real-time to the user, based upon individual delivery parameters of the user, further comprises:
comparing semantic elements of a subset of the learning objects with semantic elements of a plurality of profile objects that profile the individual delivery parameters of the user.

41. The method of claim 37, wherein the individual delivery parameters of the user include a language preference of the user, a technological capability of a computer system used by the user to access the e-learning content, and information as to e-learning content with which the student is familiar.

42. The method of claim 37, further comprising:
testing the user's knowledge of the e-learning content prior to assembly and delivery, to thereby assist in determining the at least one of the learning objects.

43. An article of manufacture, which comprises a computer readable medium having stored thereon instructions for carrying out a method for delivering e-learning content, the method comprising:
accumulating course content by a first code segment;
defining the course content in terms of discrete, reusable learning objects by a second code segment;
determining a subset of the learning objects for distribution to a user based on requirements of the user by a third code segment; and
dynamically delivering the subset of learning objects to the user by a fourth code segment.

44. The article of manufacture of claim 43, wherein the requirements of the user include a language preference of the user, a technological capability of a computer system used by the user to access the e-learning content, and information as to e-learning content with which the student is familiar.

45. The article of manufacture of claim 44, wherein the requirements of the user are separately stored within a database, and further wherein the third code segment determines the subset of learning objects by semantically matching the requirements to the subset of learning objects.

46. The article of manufacture of claim 43, wherein the first code segment further comprises:
a code segment for presenting a plurality of templates to a course developer, for entering the course content into the templates for accumulation.

47. An e-learning development and distribution tool for providing course content, comprising:
means for accumulating and storing a plurality of discrete software entities, wherein each entity embodies one aspect of presenting, accessing or explaining the course content; and
means for assembling and delivering at least one of the discrete entities to at least one student in response to an input from the student in approximately real-time, such that the student receives an individualized version of the course content.

48. The tool of claim 47, further comprising:
means for characterizing individual delivery parameters of the student, from which the means for assembling and delivering determines the at least one discrete entity to deliver.
